(19) United States
(12) Patent Application Publication
(10) Pub. No.: US 2016/0141091 A1
(43) Pub. Date: May 19, 2016

(54) COUPLED INDUCTOR, MAGNET, AND MULTI-LEVEL INVERTER

(71) Applicant: HUAWEI TECHNOLOGIES CO., LTD., Shenzhen (CN)

(72) Inventors: Lei SHI, Shanghai (CN); Fei YE, Shanghai (CN); Dianbo FU, Plano, TX (US)

(73) Assignee: HUAWEI TECHNOLOGIES CO., LTD., Shenzhen (CN)

(21) Appl. No.: 14/942,340

(22) Filed: Nov. 16, 2015

(30) Foreign Application Priority Data
Nov. 17, 2014 (CN) 201410654484.1

(51) Int. Cl. H01F 27/26; H01F 27/24; H01F 27/28; H02M 7/00

(52) U.S. Cl. CPC H01F 27/263; H02M 7/003; H01F 27/24; H01F 27/28

(57) ABSTRACT

An inductor, includes: a central post including a plurality of magnets, where each magnet includes an inductor and a primary magnetic core. The inductor at least partially surrounds the primary magnetic core and includes an auxiliary magnetic core and a winding. The winding 117 is embedded inside the auxiliary magnetic core and encircles the primary magnetic core 114. An upper jaw is connected to an upper end of the central post and a lower jaw is connected to a lower end of the central post 110. The upper jaw, lower jaw 130, and the primary magnetic core jointly form a magnetic path.

### CROSS-REFERENCE TO RELATED APPLICATION

This application claims priority to Chinese Patent Application No. 201410654484.1, filed on Nov. 17, 2014, which is hereby incorporated by reference in its entirety.

### TECHNICAL FIELD

Embodiments of the present invention relate to the field of circuits, and in particular, to a coupled inductor, a magnet, and a multi-level inverter.

### BACKGROUND

In recent years, a multi-level frequency inverter applied to the field of high voltages and high power attracts great attention of the power electronics industry. A multi-level inverter may convert a direct current into an alternating current. For example, the multi-level inverter may use a coupled inductor to combine several level stages into a step wave, to approximate a sine output voltage, that is, to output an alternating current.

When the multi-level inverter outputs more levels, an output signal is more approximate to a sine signal, so that the complexity of filtering can be reduced. To further reduce costs of a filtering circuit, the multi-level inverter needs to output more levels. For example, a parallel branch circuit is added to an interleaved parallel circuit, so that more output levels may be formed.

However, when a quantity of parallel branch circuits increases, the complexity of a magnetic core structure of a coupled inductor increases. Because of a complex structure, a magnetic core cannot be formed and processed at a time, so that a winding needs to be wound manually, thereby resulting in the difficulty in winding the winding.

### SUMMARY

Embodiments of the present invention provide a coupled inductor, a magnet, and a multi-level inverter, which can reduce the complexity of coupled inductor processing.

According to a first aspect, an embodiment of the present invention provides a coupled inductor, including:
a central post including a plurality of magnets , where each magnet includes an inductor and a primary magnetic core. The inductor at least partially surrounds the primary magnetic core and includes an auxiliary magnetic core and a winding embedded inside the auxiliary magnetic core and encircling the primary magnetic core;
an upper jaw connected to an upper end of the central post; and
a lower jaw, connected to a lower end of the central post, where
the upper jaw, the lower jaw, and the primary magnetic core jointly form a magnetic path.

In a further aspect, the primary magnetic core is disposed inside the hollow post.

The magnetic material of the primary magnetic core and of the auxiliary magnetic core can be formed of a magnetic material of high relative magnetic permeability, and the primary magnetic core can be bonded to the inductor.

Alternatively, the magnetic material of the primary magnetic core can be formed from a magnetic material of high relative magnetic permeability, and the magnetic material of the auxiliary magnetic core of the inductor can be formed from a magnetic material of low relative magnetic permeability. The primary magnetic core can be by way of sintered or bonded to the inductor.

According to further embodiment provides a magnet, including an inductor and a primary magnetic core, where the inductor surrounds the primary magnetic core. The inductor includes an auxiliary magnetic core and a winding embedded inside the auxiliary magnetic core and encircling the primary magnetic core.

The primary magnetic core and the auxiliary magnetic core can be formed from a magnetic material of high relative magnetic permeability. The primary magnetic core can be connected to the inductor via bonding.

Alternatively, the primary magnetic core can be formed from a magnetic material of high relative magnetic permeability, and the auxiliary magnetic core of the inductor can be formed from a magnetic material of low relative magnetic permeability. The primary magnetic core can be connected to the inductor by sintering or bonding.

A further embodiment provides a multi-level inverter, including:
a power assembly configured to perform power conversion on a direct current signal, to output multiple electrical signals; and
the coupled inductor configured to perform coupling processing on the multiple electrical signals output by the power assembly, to output one multi-level signal.

A further embodiment provides a method for manufacturing a coupled inductor, including:
placing a winding in a mold, and injecting a magnetic material into the mold;
sintering the winding and the magnetic material into an integral hollow post, to form an inductor;
disposing a magnetic core inside the hollow post, to form a magnet; and
separately connecting upper ends of multiple magnets and an upper jaw, and separately connecting lower ends of the multiple magnets and a lower jaw, to form the coupled inductor.

Based on the foregoing technical solutions, in the embodiments of the present invention, a winding and an auxiliary magnetic core are integrally formed, to form an inductor. The inductor wraps a primary magnetic core to form a magnet. In this way, in the embodiments of the present invention, a winding does not need to be wound manually, thereby reducing the complexity of coupled inductor processing.

### BRIEF DESCRIPTION OF DRAWINGS

To describe the technical solutions in the embodiments of the present invention more clearly, the following briefly introduces the accompanying drawings required for describing the embodiments of the present invention. The accompanying drawings in the following description show merely some embodiments of the present invention, and a person of ordinary skill in the art may still derive other drawings from these accompanying drawings without creative efforts.

FIG. 1a and FIG. 1b are schematic block diagrams of a coupled inductor according to an embodiment of the present invention;

FIG. 2a and FIG. 2b are schematic block diagrams of a magnet according to the embodiment of the present invention;

FIG. 3 is a schematic flowchart for manufacturing a magnet according to an embodiment of the present invention;

FIG. 4 is a schematic flowchart for manufacturing a magnet according to another embodiment of the present invention;

FIG. 5 is a schematic block diagram of a coupled inductor according to another embodiment of the present invention;

FIG. 6 is a schematic block diagram of a coupled inductor according to another embodiment of the present invention;

FIG. 7 is a schematic block diagram of a multi-level inverter according to an embodiment of the present invention; and

FIG. 8 is a schematic flowchart of a method for manufacturing a coupled inductor according to an embodiment of the present invention.

### DESCRIPTION OF EMBODIMENTS

The following clearly and completely describes the technical solutions in the embodiments of the present invention with reference to the accompanying drawings in the embodiments of the present invention. The described embodiments are illustrative of the invention, but are not all encompassing. It is to be understood and appreciated that other embodiments are possible to be obtained by a person of ordinary skill in the art based on the embodiments of the present invention without creative efforts, and that all such embodiments shall fall within the protection scope of the present invention.

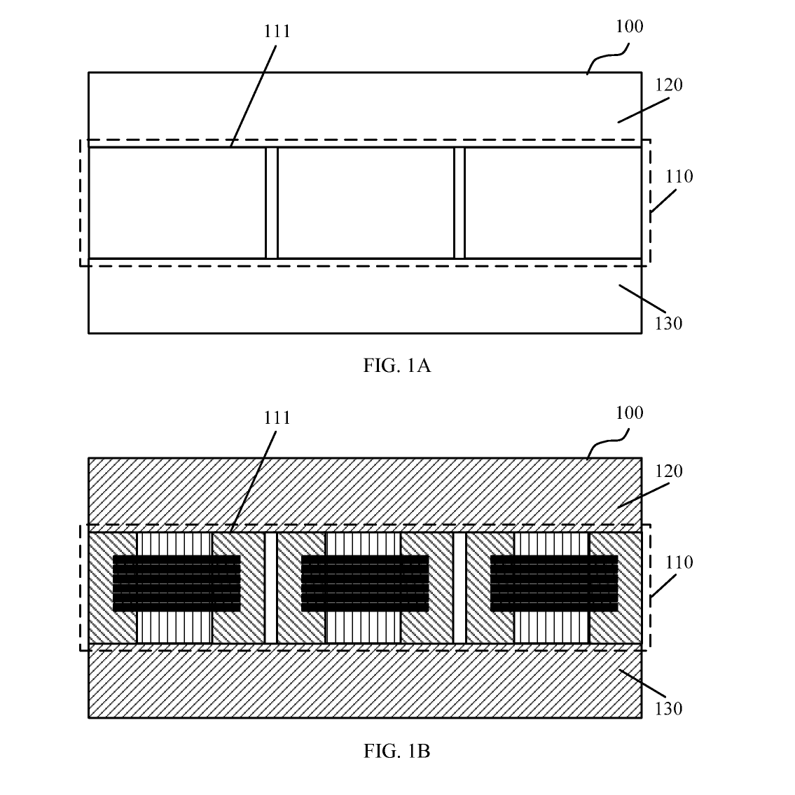

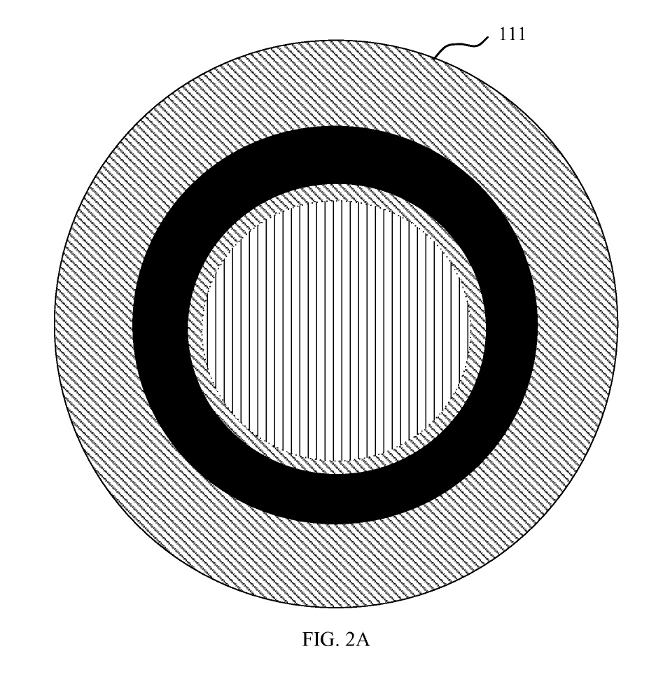

FIG. 1A and FIG. 1B are schematic block diagrams of a coupled inductor according to an embodiment of the present invention. FIG. 1A is a front view of a coupled inductor 100, and FIG. 1B is a longitudinal sectional view of the coupled inductor 100. The coupled inductor 100 includes a central post 110, an upper jaw 120, and a lower jaw 130.

The central post 110 includes multiple magnets 111, where each magnet 111 of the multiple magnets 111 includes an inductor 113 and a primary magnetic core 114, the inductor 113 wraps the primary magnetic core 114, the inductor 113 includes an auxiliary magnetic core 116 and a winding 117, and the winding 117 is embedded inside the auxiliary magnetic core 116 and encircles the primary magnetic core 114.

The upper jaw 120 is connected to an upper end of the central post 110.

The lower jaw 130 is connected to a lower end of the central post 110.

The upper jaw 120, the lower jaw 130, and the primary magnetic core 114 jointly form a magnetic path.

As shown in FIG. 1A, the central post 110 includes three magnets 111. It should be understood that FIG. 1A is only a schematic diagram, and this embodiment of the present invention makes no limitation on a quantity of magnets 111, so that implementation manners in which the central post 110 includes multiple magnets 111 shall all fall within the protection scope of this embodiment of the present invention. Specifically, a coupling factor of the coupled inductor 100 may be controlled by controlling an interval between windings.

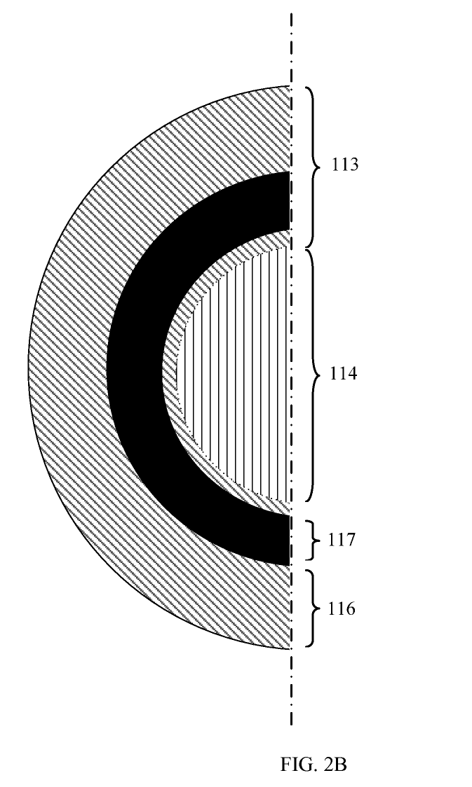

In accordance with the foregoing technical solution, the winding 117 and the auxiliary magnetic core 116 (FIGS. 2A & 2B)are integrally formed, to form the inductor 113. The inductor 113 wraps the primary magnetic core 114 to form the magnet 111. In this way, in this embodiment of the present invention, the winding does not need to be wound manually, thereby reducing the complexity of coupled inductor processing. Moreover, different magnets 111 in the coupled inductor in this embodiment of the present invention have high consistency.

Further, different magnetic materials may be selected for the primary magnetic core 114 and the auxiliary magnetic core 116, so that advantages of the different magnetic materials can be fully used. For example, features of different magnetic materials are fully used for combination-based design, for example, FeSiAl is of low loss, so that FeSiAl may be used for designing the primary magnetic core 114, which helps to reduce pressure of heat dissipation. Fe—Si has a good direct current bias feature but has great loss, so that Fe—Si may be used for designing the auxiliary magnetic core or the upper or lower jaw, which helps to dissipate heat.

Moreover, the auxiliary magnetic core 116 may increase inductance of a common-mode part of the coupled inductor 100, thereby achieving a filtering effect. That is, the coupled inductor 100 also has a filtering function, and a filtering inductor does not need to be disposed particularly, thereby achieving an objective of reducing costs.

In addition, the winding 117 and the auxiliary magnetic core 116 are integrally manufactured, thereby preventing a problem that a great insulation distance is needed when the winding is wound, improving utilization of the magnetic core and the winding, and reducing volume of the coupled inductor.

This embodiment of the present invention is described in detail below with reference to specific examples. It should be noted that these examples are only intended to help a person skilled in the art understand this embodiment of the present invention better, instead of limiting the scope of this embodiment of the present invention.

FIG. 2A and FIG. 2B are schematic block diagrams of a magnet according to the embodiment of the present invention. A structure of the magnet is described in detail with reference to FIG. 2A and FIG. 2B. FIG. 2A shows a sectional view of the magnet 111. As shown in FIG. 2A, the magnet 111 is a cylinder. It should be understood that this embodiment of the present invention makes no limitation on a shape of the magnet, and the magnet may be another post other than the cylinder. For ease of description of a structure of the magnet 111, FIG. 2B shows a half sectional view of the magnet 111.

The magnet 111 includes the inductor 113 and the primary magnetic core 114. The inductor 113 is an integral hollow post formed by sintering a magnetic material and the winding 117. The auxiliary magnetic core 116 is located on an outer side of the winding 117. Usually, the outside of the winding 117 is wrapped with an insulation material. It should be understood that, due to a processing technology, there is one layer of magnetic material on an inner side (between the winding 117 and the primary magnetic core 114) of the winding 117. The primary magnetic core 114 is a post formed by sintering a magnetic material, and is wrapped by the inductance, to jointly form the magnet 111.

Optionally, as an embodiment, the inductor 113 is an integral hollow post, and the primary magnetic core 114 is disposed inside the hollow post.

Optionally, as another embodiment, a magnetic material of high relative magnetic permeability μ is selected for the primary magnetic core 114. The auxiliary magnetic core 116 mainly plays a role of enhancing leakage inductance of a common-mode magnetic circuit, so that a magnetic material with a low value μ may be selected, or a magnetic material with a high value μ may also be selected, thereby achieving a filtering effect by increasing an air gap.

It can be understood by a person skilled in the art that the magnetic material with a high value μ is generally a material such as ferrite, silicon steel, an amorphous material or a nano-crystal material, and the magnetic material with a low value μ is generally a material such as FeSiAl or Fe—Si.

Optionally, as an embodiment, a magnetic material of the primary magnetic core 114 is a magnetic material of high relative magnetic permeability, a magnetic material of the auxiliary magnetic core 116 of the inductor 113 is a magnetic material of high relative magnetic permeability, and the primary magnetic core 114 is connected to the inductor 113 in a bonding manner.

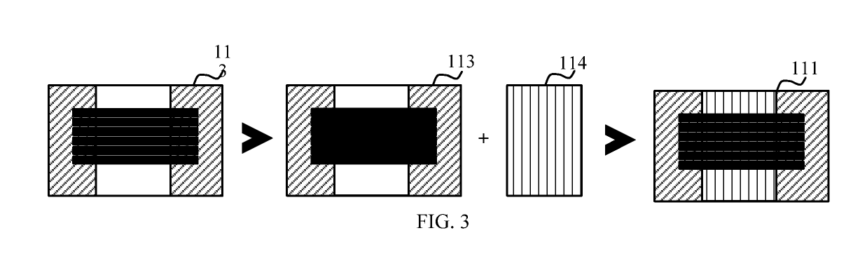

FIG. 3 is a schematic flowchart for manufacturing a magnet according to an embodiment of the present invention. For example, magnetic materials with a high value μ are selected for separately manufacturing an inductor 113 and a primary magnetic core 114. The primary magnetic core 114 is an integrally formed hollow post formed by sintering a magnetic material and a winding 117. In this case, a method shown in FIG. 3 may be used to connect the primary magnetic core 114 and the inductor 113 in a bonding manner, to form a magnet 111.

Optionally, as another embodiment, a magnetic material of the primary magnetic core 114 is a magnetic material of high relative magnetic permeability, a magnetic material of an auxiliary magnetic core 116 of the inductor 113 is a magnetic material of low relative magnetic permeability, and the primary magnetic core 114 is connected to the inductor 113 in a sintering manner, or the primary magnetic core 114 is connected to the inductor 113 in a bonding manner.

Usually, selecting the primary magnetic core 114 with high relative magnetic permeability μ helps to achieve a good coupling effect.

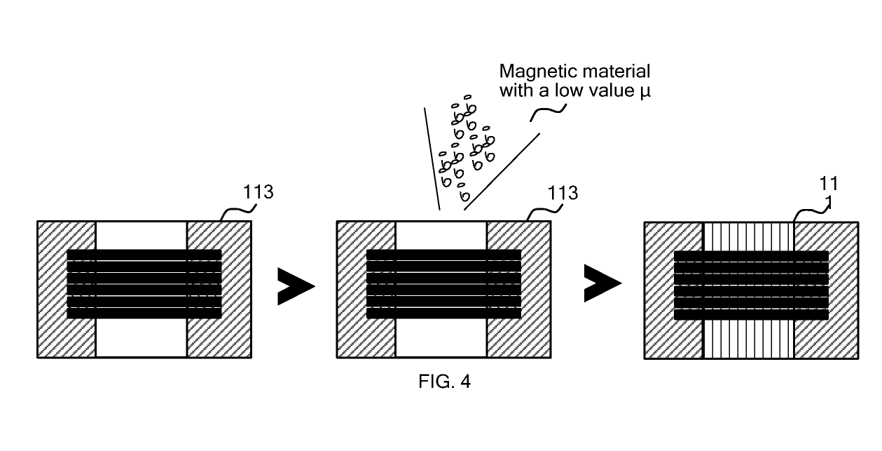

FIG. 4 is a schematic flowchart for manufacturing a magnet according to another embodiment of the present invention. For example, as shown in FIG. 4, a magnetic material with a high value μ is first selected for manufacturing an inductor 113, and the magnetic material and a winding 117 are sintered into a hollow post that is hollow in the middle. Then, a magnetic material with a low value μ is poured into the hollow post, and sintering is performed once again, to form an integrally formed magnet 111.

Alternatively, a magnetic material with a high value μ may also be first selected for manufacturing an inductor 113, and the magnetic material and a winding 117 are sintered into a hollow post that is hollow in the middle. Then, a magnetic material with a low value μ is selected for manufacturing a primary magnetic core 114. Finally, the method shown in FIG. 3 is used to connect the primary magnetic core 114 and the inductor 113 in a bonding manner, to form a magnet 111.

Optionally, as another embodiment, multiple magnets 111 are integrally formed to form a central post 110.

FIG. 5 is a schematic block diagram of a coupled inductor according to another embodiment of the present invention. It should be understood that FIG. 5 is only a schematic diagram, and this embodiment of the present invention makes no limitation on a quantity of magnets 111, so that implementation manners in which a central post 110 includes multiple magnets 111 shall all fall within the protection scope of this embodiment of the present invention.

As shown in FIG. 5, three magnets 111 are integrally formed. Specifically, when a coupled inductor 100 shown in FIG. 5 is manufactured, an integrally formed inductor (which includes three windings and has three hollow holes) may be manufactured first. Then, three primary magnetic cores 114 are manufactured, and the three primary magnetic cores 114 are respectively placed into the foregoing three hollow holes. Finally, the primary magnetic cores 114 are connected to the inductor in a bonding manner, to form the magnets 111.

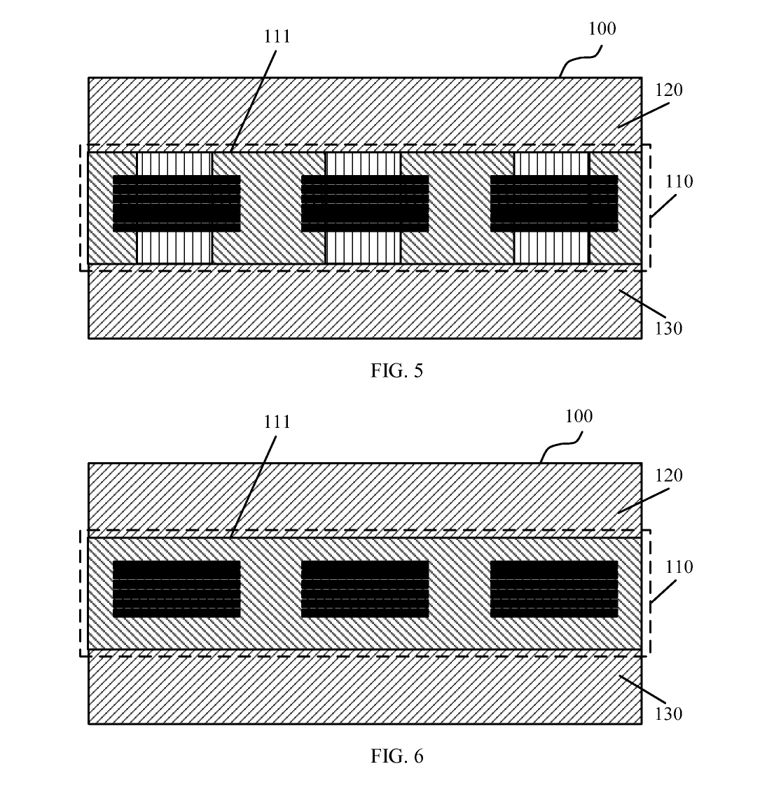

Alternatively, in a case in which a high coupling coefficient is not required, magnetic materials with a low value μ may be selected for both the primary magnetic core 114 and an auxiliary magnetic core 116. FIG. 6 is a schematic block diagram of a coupled inductor according to another embodiment of the present invention. In this case, as shown in FIG. 6, a magnetic material with a low value μ may be directly selected, and the magnetic material and multiple windings are sintered into an integrally formed magnet 111.

Optionally, as another embodiment, a winding 117 of each magnet 111 of multiple magnets 111 has a same winding direction.

Optionally, as another embodiment, magnetic materials of both an upper jaw 120 and a lower jaw 130 are magnetic materials of high relative magnetic permeability.

Optionally, as another embodiment, the upper jaw 120 and the lower jaw 130 are separately connected to a central post 110 in a bonding manner.

As shown in FIG. 2a, an embodiment of the present invention further provides a magnet. A magnet 111 includes an inductor 113 and a primary magnetic core 114, where the inductor 113 wraps the primary magnetic core 114, the inductor 113 includes an auxiliary magnetic core 116 and a winding 117, and the winding 117 is embedded inside the auxiliary magnetic core 116 and encircles the primary magnetic core 114. According to a method in this embodiment of the present invention, when a magnet is manufactured, a winding does not need to be wound manually, so that the complexity of magnet manufacturing can be reduced.

FIG. 2A shows a sectional view of the magnet 111. As shown in FIG. 2A, the magnet 111 is a cylinder. It should be understood that this embodiment of the present invention makes no limitation on a shape of the magnet, and the magnet may be another post other than the cylinder. The magnet 111 includes the inductor 113 and the primary magnetic core 114. The inductor 113 is an integrally formed hollow post formed by sintering a magnetic material and the winding 117. The auxiliary magnetic core 116 is located on an outer side of the winding 117. Usually, the outside of the winding 117 is wrapped with an insulation material. It should be understood that, due to a processing technology, there is one layer of magnetic material on an inner side (between the winding 117 and the primary magnetic core 114) of the winding 117. The primary magnetic core 114 is a post formed by sintering a magnetic material, and is wrapped by the inductor, to jointly form the magnet 111.

Optionally, as another embodiment, a magnetic material of the primary magnetic core 114 is a magnetic material of high relative magnetic permeability, a magnetic material of the auxiliary magnetic core 116 of the inductor 113 is a magnetic material of high relative magnetic permeability, and the primary magnetic core 114 is connected to the inductor 113 in a bonding manner.

For a method for bonding the primary magnetic core 114 and the inductor 113, reference may be made to the method described in FIG. 3; to prevent repetition, details are not described herein again.

Optionally, as another embodiment, a magnetic material of the primary magnetic core 114 is a magnetic material of high relative magnetic permeability, a magnetic material of the auxiliary magnetic core 116 of the inductor 113 is a magnetic material of low relative magnetic permeability, and the primary magnetic core 114 is connected to the inductor 113 in a sintering manner, or the primary magnetic core 114 is connected to the inductor 113 in a bonding manner.

For a method for connecting the primary magnetic core 114 and the inductor 113, reference may be made to the methods described in FIG. 3 and FIG. 4; to prevent repetition, details are not described herein again.

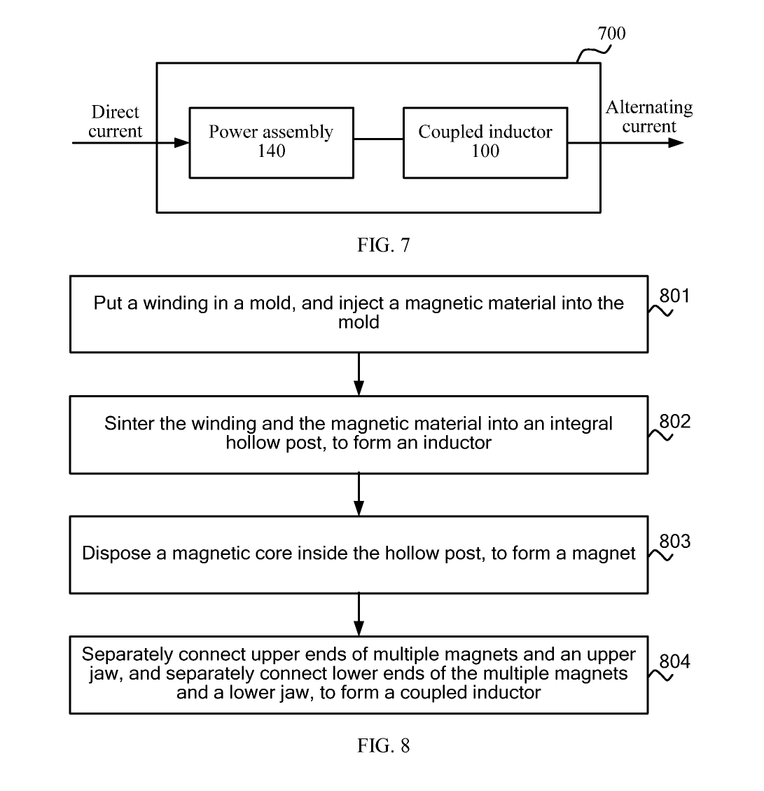

FIG. 7 is a schematic block diagram of a multi-level inverter according to an embodiment of the present invention. As shown in FIG. 7, a multi-level inverter 700 includes a power assembly 140 and a coupled inductor 100, and can convert a direct current into an alternating current.

The power assembly 140 is configured to perform power conversion on a direct current signal, to output multiple electrical signals.

The coupled inductor 100 is configured to perform coupling processing on the multiple electrical signals output by the power assembly 140, to output one multi-level signal. The coupled inductor 100 has the structure described above; to prevent repetition, details are not described herein again.

FIG. 8 is a schematic flowchart of a method for manufacturing a coupled inductor according to an embodiment of the present invention.

801: Put a winding in a mold, and inject a magnetic material into the mold.

802: Sinter the winding and the magnetic material into an integral hollow post, to form an inductor.

803: Dispose a magnetic core inside the hollow post, to form a magnet.

804: Separately connect upper ends of multiple magnets and an upper jaw, and separately connect lower ends of the multiple magnets and a lower jaw, to form the coupled inductor.

In this way, in this embodiment of the present invention, a winding does not need to be wound manually, thereby reducing the complexity of coupled inductor processing. Moreover, different magnets in a coupled inductor in this embodiment of the present invention have high consistency.

The foregoing descriptions are merely specific embodiments of the present invention, but are not intended to limit the protection scope of the present invention. Any modification or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An inductor, comprising:
a central post comprising a plurality of magnets, wherein at least one of said magnets comprises an inductor and a primary magnetic core, the inductor at least partially surrounding the primary magnetic core and comprising an auxiliary magnetic core and a winding embedded inside the auxiliary magnetic core and encircling the primary magnetic core;
an upper jaw connected to an upper end of the central post; and
a lower jaw connected to a lower end of the central post, wherein
the upper jaw, the lower jaw, and the primary magnetic core jointly form a magnetic path.

2. The inductor according to claim 1, wherein the inductor is an integral hollow post, and the primary magnetic core is disposed inside the hollow post.

3. The coupled inductor according to claim 1, wherein the primary magnetic core and the auxiliary magnetic core are each formed from a magnetic material of high relative magnetic permeability, wherein the primary magnetic core is bonded to the inductor.

4. The inductor according to claim 1, wherein the primary magnetic core is formed from a magnetic material of high relative magnetic permeability, and the auxiliary magnetic core of the inductor is formed from a magnetic material of low relative magnetic permeability, wherein the primary magnetic core is connected to the inductor via sintering or bonding.

5. The inductor according to claim 1, wherein the plurality of magnets is integrally formed to form the central post.

6. The inductor according to claim 1, wherein the winding of each magnet is provided with a common winding direction.

7. The inductor according to claim 1, wherein magnetic materials of both the upper jaw and the lower jaw are magnetic materials of high relative magnetic permeability.

8. The inductor according to claim 1, wherein the upper jaw and the lower jaw are separately bonded to the central post.

9. A magnet, comprising an inductor and a primary magnetic core, wherein the inductor at least partially surrounds the primary magnetic core and comprises an auxiliary magnetic core and a winding embedded inside the auxiliary magnetic core and encircles the primary magnetic core.

10. The magnet according to claim 9, wherein the primary magnetic core and the auxiliary magnetic core are each formed from a magnetic material of high relative magnetic permeability, wherein the primary magnetic core is bonded to the inductor.

11. The magnet according to claim 9, wherein the primary magnetic core is formed from a magnetic material of high relative magnetic permeability, and the auxiliary magnetic core is formed from a magnetic material of low relative magnetic permeability, wherein the primary magnetic core is sintered or bonded to the inductor.

12. A multi-level inverter, comprising:
a power assembly to provide for power conversion on a direct current to output a plurality of electrical signals, and an inductor to perform coupling of the electrical signals output by the power supply to a single multi-level signal, whereby the inductor comprises a central post comprising a plurality of magnets, wherein at least one of said magnets comprises an inductor and a primary magnetic core, the inductor at least partially surrounding the primary magnetic core and comprising an auxiliary magnetic core and a winding embedded inside the auxiliary magnetic core and encircling the primary magnetic core;
an upper jaw connected to an upper end of the central post; and
a lower jaw connected to a lower end of the central post, wherein
the upper jaw, the lower jaw, and the primary magnetic core jointly form a magnetic path.
